(19) United States
(12) Patent Application Publication
(10) Pub. No.: US 2011/0240702 A1
(43) Pub. Date: Oct. 6, 2011

(54) READY-WRITE SAFETY GLASSES SYSTEM

(76) Inventor: Robert Zajac, Swedesboro, NJ (US)

(21) Appl. No.: 13/077,622

(22) Filed: Mar. 31, 2011

Related U.S. Application Data
(60) Provisional application No. 61/320,313, filed on Apr. 2, 2010.

(51) Int. Cl. G02C 11/00; A45F 5/00

(52) U.S. Cl. 224/576; 224/181

(57) ABSTRACT

A safety goggle writing utensil holder comprising a pair of safety goggles; and a writing utensil holder. The writing utensil holder is integral with the pair of safety goggles such that a writing utensil is removably-secured via the writing utensil holder. Further, the writing utensil holder is horizontally-oriented on the pair of safety goggles. The safety goggles are used for light construction tasks, optionally having ventilated frames for heavy construction and fixed, soft frame welding goggles. The writing utensil holder comprises a deformable spring-loaded clip having at least one tension fit or at least one contour-molded fitting.

### CROSS-REFERENCE TO RELATED APPLICATION

The present application is related to and claims priority from prior provisional application Ser. No. 61/320,313, filed Apr. 2, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of glasses and more specifically relates to safety glasses comprising a writing utensil holder, entitled herein as Ready-write safety glasses system.

### 2. Description of the Related Art

Everyday thousands of professional contractors and amateur do-it-yourselfers embark on a variety of construction and home improvement tasks such as building an addition onto a home, replacing paneling or flooring and installing cupboards and countertops. Requiring varying degrees of skill, as well as a good eye, the results achieved by successfully completing these tasks can be enjoyed for years.

Regardless of whether one is a professional contractor, or simply a husband and wife duo making improvements to their living space, most would agree that safety on the job is of utmost concern. In particular, donning protective gear when completing various construction or household repair task is crucial in order to ensure personal safety while working. Heavy duty work gloves, a sturdy helmet and protective knee pads are but a few of the types of safety gear that consumers may wear when performing construction tasks. Specifically, a simple pair of safety glasses provides contractors and do-it-yourselfers a reliable means of protecting their eyes from exposure to dust, debris, sharp and/or flying objects when on the job. Safety glasses are designed to protect individuals during home improvement tasks. Unfortunately, during these times a user may also find a need to use a writing utensil that may not be readily accessible.

Various attempts have been made to solve problems found in glasses art. Among these are found in: U.S. Pat. No. 5,430,503 to Colitz; U.S. Pat. No. 6,792,619 to Morris; and U.S. Pat. No. 7,018,037 to Jouver. This prior art is representative of glasses art.

Ideally, ready-write safety glasses should be user-friendly and yet, would operate reliably and be manufactured at a modest expense. Thus, a need exists for safety glasses to provide ease of access to a writing utensil to avoid the above-mentioned problems.

### BRIEF SUMMARY OF THE INVENTION

In view of the foregoing disadvantages inherent in the known glasses art, the present invention provides novel safety glasses with a writing utensil attachment means. The general purpose of the present invention, which will be described subsequently in greater detail, is to provide safety and convenience for safety glass wearers by providing ease of access to a writing utensil. The features of the invention which are believed to be novel are particularly pointed out and distinctly claimed in the concluding portion of the specification. These and other features, aspects, and advantages of the present invention will become better understood with reference to the following drawings and detailed description.

The present invention, safety goggle writing utensil holder system as disclosed herein preferably comprises: a pair of safety goggles; and a writing utensil holder. The writing utensil holder may be integral with the pair of safety goggles such that a writing utensil is removably-secured via the writing utensil holder. Further, the writing utensil holder is preferably horizontally-oriented on the pair of safety goggles. The writing utensil holder is removably-coupleable to a right or left ear piece on the pair of safety goggles in alternate embodiments. The writing utensil holder is designed to temporarily hold a cylindrically-shaped writing utensil such as a pencil, pen, or sharpie via at least one deformable spring-loaded clip using the tension fit.

The pair of safety goggles may comprise ventilated frames and a heavy duty plastic framework and/or a rubber framework for holding at least one anti-fogging, shatterproof lens. When a rubber framework is used, a fixed, soft frame may also be used as in activities such as welding. Also the pair of safety goggles preferably comprises ergonomic ear pieces.

A kit is embodied herein for the ready-write safety glasses system comprising: a pair of safety goggles; a writing utensil holder; at least one writing utensil; and a set of user instructions. Optionally, a specialty glasses holder/case may be included.

In accordance with the embodiments of the present invention a preferred method of use is disclosed herein comprising: donning the safety goggles; inserting a writing utensil into a safety goggle writing utensil holder system; retrieving the writing utensil from the safety goggle writing utensil holder system when needed; and re-inserting the writing utensil into the safety goggle writing utensil holder system when a user is finished using the writing utensil.

The present invention holds significant improvements and serves as Ready-write safety glasses system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, ready-write safety glasses, constructed and operative according to the teachings of the present invention.

FIG. 1 shows a perspective view illustrating a ready-write safety glasses system in an ‘in-use’ condition according to an embodiment of the present invention.

FIG. 2A shows a perspective view illustrating a safety goggle writing utensil holder of the ready-write safety glasses system according to an embodiment of the present invention.

FIG. 2B shows a perspective view illustrating a removable safety goggle writing utensil holder of the ready-write safety glasses system according to an embodiment of the present invention.

FIG. 3 is another perspective view illustrating the safety goggle writing utensil holder of the ready-write safety glasses system according to an embodiment of the present invention.

FIG. 4 is a flowchart illustrating a method of use for the ready-write safety glasses system according to an embodiment of the present invention of FIGS. 1-3.

The various embodiments of the present invention will hereinafter be described in conjunction with the appended drawings, wherein like designations denote like elements.

### DETAILED DESCRIPTION

As discussed above, embodiments of the present invention relate to glasses and more specifically relates to safety glasses comprising a writing utensil holder as used to improve the safety and convenience of its users.

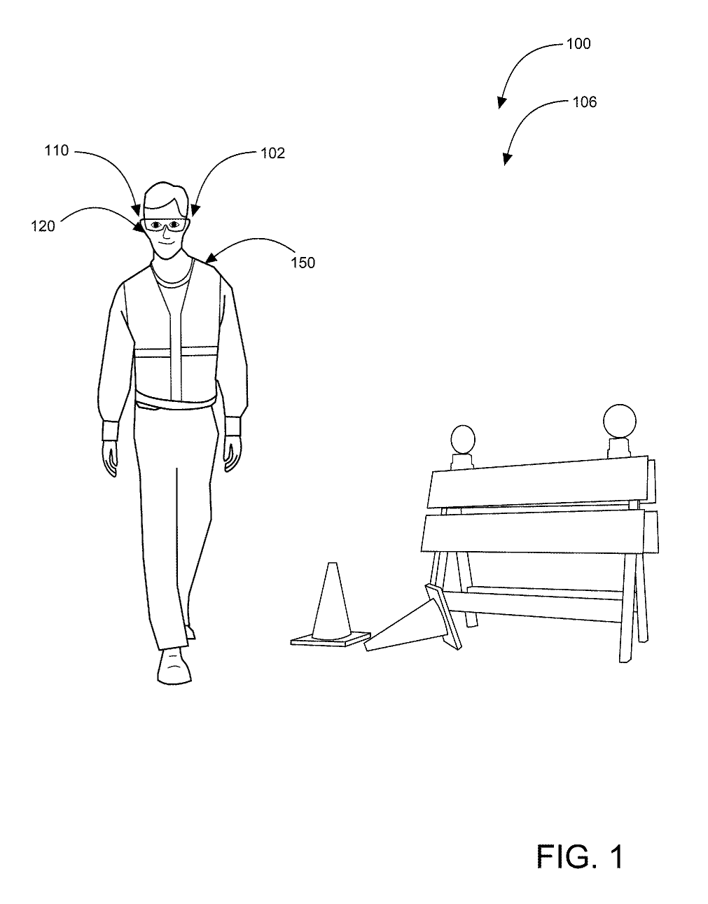

Referring now to FIG. 1 showing a perspective view of ready-write safety glasses system 100 in ‘in-use’ condition 106 according to an embodiment of the present invention. Ready-write safety glasses system 100 preferably comprises safety goggle writing utensil holder 102. Further, safety goggle writing utensil holder 102 may provide construction workers, contractors, and do-it-yourselfers superior eye protection and on-the-job convenience with respect to both safety and efficiency.

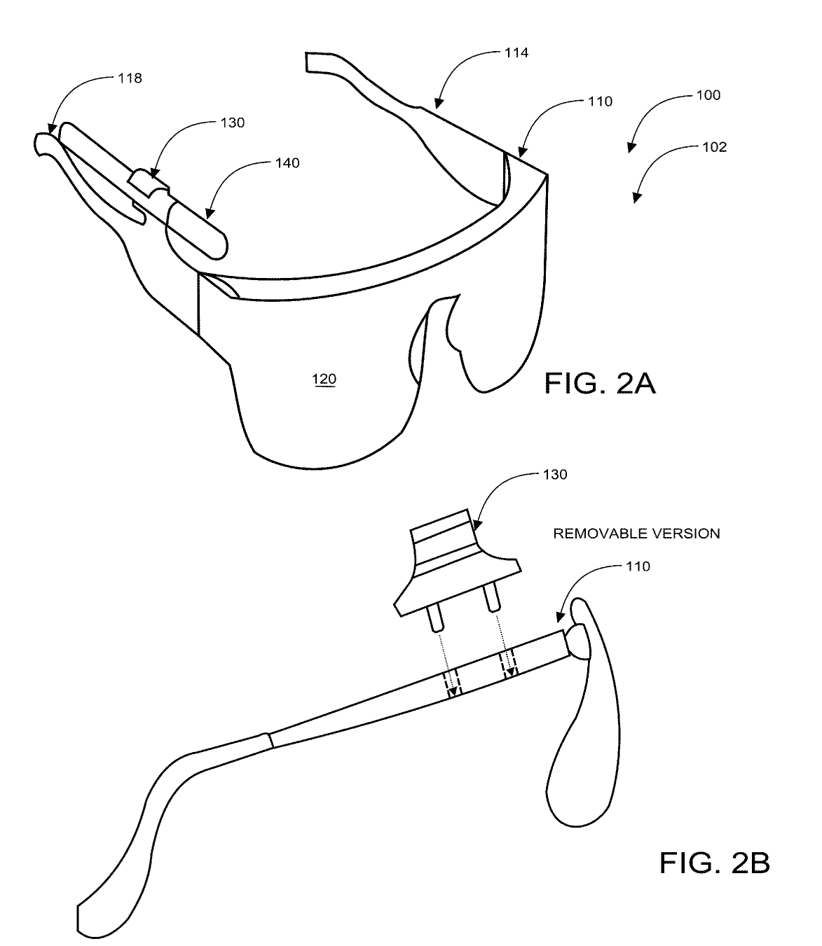

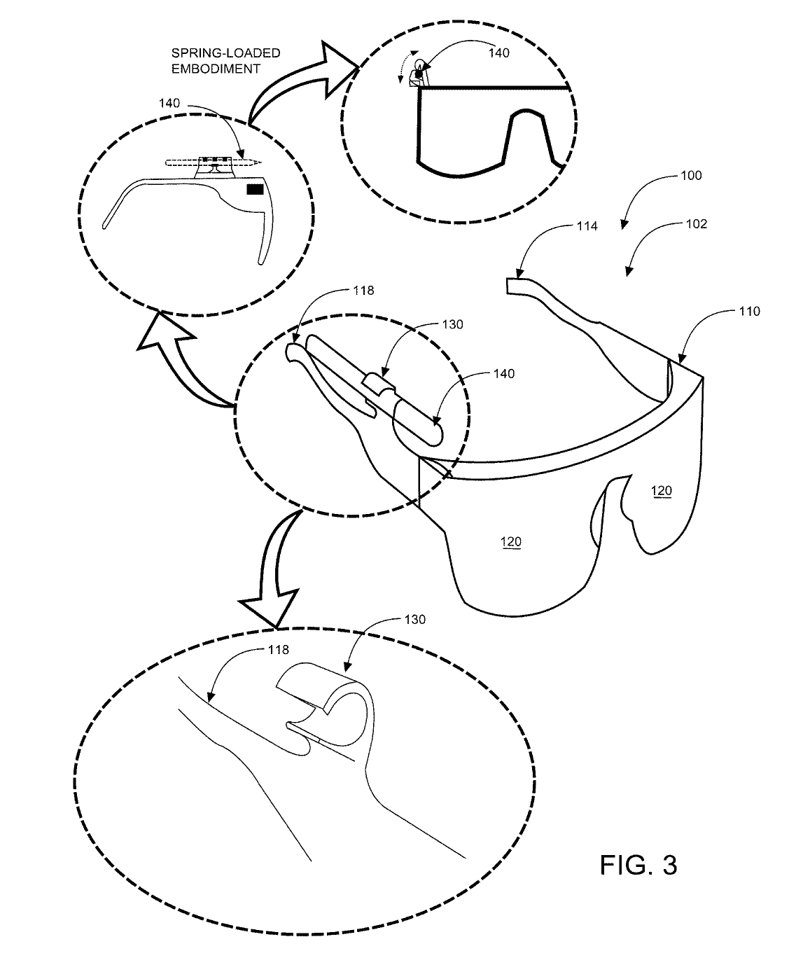

Referring now to FIGS. 2A-3 showing perspective views of safety goggle writing utensil holder 102 of ready-write safety glasses system 100 according to embodiments of the present invention. Safety goggle writing utensil holder 102 may be produced in a variety of designs to accommodate various construction tasks and customized user-needs. Safety goggle writing utensil holder 102 preferably also functions to provide eye protection especially from flying debris in areas such as construction, machining, and other locations/conditions where eye protection is required or necessary.

Further, safety goggle writing utensil holder 102 includes a pair of safety goggles 110 and writing utensil holder 130 as shown best in FIGS. 2A & 2B. Writing utensil holder 130 is preferably integral with pair of safety goggles 110 (within the preferred embodiment shown) such that writing utensil 140 is removably-secured via writing utensil holder 130 in a state of tension (compression) as shown in FIG. 2A. Writing utensil 140 may include but is not limited to any cylindrically shaped writing instrument such as a pencil, pen, sharpie, etc.

However, in an alternate embodiment writing utensil holder 130 may be removably-coupleable to safety goggles 110 via fasteners and/or compression-tensioning means (friction-fit to side arms—left ear piece 114 or right ear piece 118) as shown in FIG. 2B. In this embodiment, user 150 may remove writing utensil holder 130 at their preference from a left to a right side for example, or when writing utensil 140 will not be necessary when user 150 is donning safety goggles 110. Also, in this embodiment writing utensil holder 130 may be removably-coupleable to other forms of eyewear such as but not limited to sunglasses, eyeglasses, etc.

Further, in alternate embodiments a spring-loaded clip may be used wherein a spring may be depressed to fit writing utensil 140 between two fingers. The fingers are normally in tension, thus when writing utensil 140 is disposed therein it to is held in stasis in tension.

Writing utensil holder 130 is preferably removably coupleable to left ear piece 114 or right ear piece 118 on pair safety goggles 110. Left ear piece 114 and right ear piece 118 of safety goggles 110 preferably include ergonomically designed left ear piece 114 and right ear piece 118 so as to improve comfort for user 150. Left ear piece 114 and right ear piece 118 may include cushioning to prevent left ear piece 114 and right ear piece 118 from inwardly depressing into temples of user 150, or left ear piece 114 and right ear piece 118 may be designed in a way that the surface area of contact of left ear piece 114 and right ear piece 118 on temples of user 150 is limited.

Further, writing utensil holder 130 is preferably horizontally-oriented on pair of safety goggles 110, as shown. In the main embodiment as shown in FIGS. 1-3, writing utensil holder 130 comprises at least one deformable spring-loaded clip or at least one spring-loaded clamp whereby the clip/clamp is normally in tension such that when writing utensil 140 is inserted the clip/clamp creates an inwardly-directed friction force. In this way the deformable spring-loaded clip comprises at least one tension fit. The tension fit provides a secure customized fit to a user-selected writing utensil 140 as when writing utensil is inserted into writing utensil holder 130. The tension fit of writing utensil holder 130 will grasp and conform to the cylindrical contours of writing utensil 140. When using a spring-loaded clip for writing utensil 130, the spring-loaded clip preferably comprises at least one contour-molded fitting. When using a contour-molded-fitting, the fitting is sized during manufacturing to fit most standard-sized cylindrical shaped writing utensils 140 such as a pen or pencil such that writing utensils 140 may be slid in.

Safety goggles 110 may include flexible wrap-around glasses and may have ventilated frames, as previously mentioned along with heavy duty plastic framework for use by construction workers when flying debris is prevalent. Alternatively, pair of safety goggles 110 may comprise a fixed, soft frame for use during activities involving high temperatures such as during welding and machining. Both the heavy duty plastic framework and the fixed, soft frame of safety goggles 110 house at least one lens 120. Properties of lens 120 may include, but are not limited to anti-fogging and shatter-proofing. In alternate embodiments lens 120 may comprise a plurality of prescription lens.

Whether needed to mark a piece of molding for cutting, take notes on a blue print, or take accurate measurements when hanging fixtures, use of ready-write safety glasses system 100 may substantially ensure that writing utensil 140 may be available when needed. Eliminating the need to stop the task at hand, simply in order to search for writing utensil 140, use of safety goggle writing utensil holder 102 preferably allows user 150 to complete a designated task quickly and with ease. A fully functioning pair of protective eye wear, safety goggle writing utensil holder 102 preferably protects the eyes of user 150 from exposure to dust, dirt, sharp object or other debris when on the job. As such, safety goggle writing utensil holder 102 may prove an invaluable safety tool at any work site. Durably constructed, ready-write safety glasses system 100 preferably may withstand years of continual use.

Ready-write safety glasses system 100 according to an embodiment of the present invention of FIGS. 1-3 may comprise kit 340. Kit 340 may comprise the following parts: pair of safety goggles 110; writing utensil holder 130; at least one writing utensil 140; and a set of user instructions. Optionally, a special-fit case/holder may be included. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately.

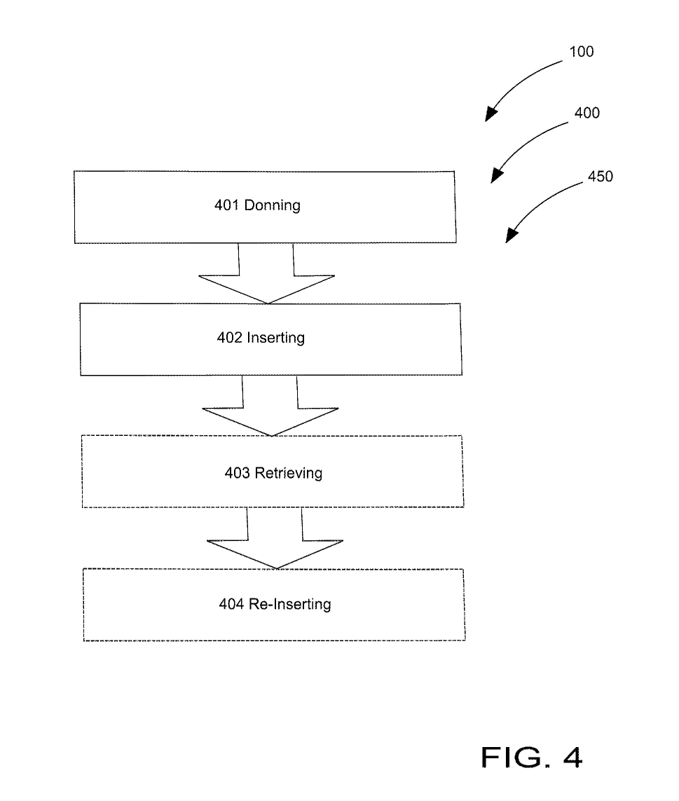

FIG. 4. shows flowchart 450 illustrating method of use 400 according to an embodiment of the present invention of FIGS. 1-3. A method of using (at least herein enabling method of use 400) ready-write safety glasses system 100 may comprise the steps of: step one 401 donning safety goggles 110; step two 402 inserting writing utensil 140 into safety goggle writing utensil holder 102; step three 403 retrieving writing utensil 140 from safety goggle writing utensil holder 102 when needed; and step four 404 re-inserting writing utensil 140 into safety goggle writing utensil holder 102 when user 150 is finished using writing utensil 140.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A safety goggle writing utensil holder system comprising:
a pair of safety goggles; and
a writing utensil holder;
wherein said writing utensil holder is integral with said pair of safety goggles such that a writing utensil is removably-secured via said writing utensil holder.

2. The safety goggle writing utensil holder system of claim 1 wherein said writing utensil holder comprises at least one deformable spring-loaded clip.

3. The safety goggle writing utensil holder system of claim 1 wherein said writing utensil holder comprises at least one spring-loaded clamp.

4. The safety goggle writing utensil holder system of claim 1 wherein said writing utensil holder is horizontally-oriented on said pair of safety goggles

5. The safety goggle writing utensil holder system of claim 2 wherein said deformable spring-loaded clip further comprises at least one tension fit.

6. The safety goggle writing utensil holder system of claim 2 wherein said spring-loaded clip further comprises at least one contour-molded fitting.

7. The safety goggle writing utensil holder system of claim 1 wherein said writing utensil holder is removably coupleable to a left ear piece on said pair of safety goggles.

8. The safety goggle writing utensil holder system of claim 1 wherein said writing utensil holder is removably coupleable to a right ear piece on said pair of safety goggles.

9. The safety goggle writing utensil holder system of claim 1 wherein said pair of safety goggles comprises ventilated frames.

10. The safety goggle writing utensil holder system of claim 1 wherein said pair of safety goggles comprise a fixed, soft frame for use when welding.

11. The safety goggle writing utensil holder system of claim 1 wherein said pair of safety goggles comprise a heavy duty plastic framework for holding at least one lens.

12. The safety goggle writing utensil holder system of claim 1 wherein said pair of safety goggles comprise a rubber framework for holding at least one lens.

13. The safety goggle writing utensil holder system of claim 1 wherein said pair of safety goggles comprise ergonomic ear pieces.

14. The safety goggle writing utensil holder system of claim 1 wherein said pair of safety goggles further comprise anti-fogging, shatterproof lenses.

15. The safety goggle writing utensil holder system of claim 1 wherein said writing utensil holder temporarily holds a cylindrically-shaped pencil.

16. The safety goggle writing utensil holder system of claim 1 wherein said writing utensil holder temporarily holds a cylindrically-shaped pen.

17. The safety goggle writing utensil holder system of claim 1 wherein said writing utensil holder temporarily holds a sharpie.

18. A safety goggle writing utensil holder system comprising:
a pair of safety goggles comprises ventilated frames and a heavy duty plastic framework for holding at least one anti-fogging, shatterproof lenses; and
a writing utensil holder comprising at least one deformable spring-loaded clip having at least one tension fit;
wherein said writing utensil holder is integral with said pair of safety goggles such that a writing utensil is removably-secured via said writing utensil holder;
wherein said writing utensil holder is horizontally-oriented on said pair of safety goggles;
wherein said writing utensil holder is removably coupleable to a right or left ear piece on said pair of safety goggles;
wherein said writing utensil holder temporarily holds a cylindrically-shaped writing utensil; and
wherein said pair of safety goggles comprise ergonomic ear pieces.

19. The safety goggle writing utensil holder system of claim 17 further comprising a kit including: said a pair of safety goggles; said writing utensil holder; said at least one writing utensil; and a set of user instructions.

20. A method of using Ready-write safety glasses system comprising the steps of:
donning safety goggles;
inserting a writing utensil into a safety goggle writing utensil holder;
retrieving said writing utensil from said safety goggle writing utensil holder when needed; and
re-inserting said writing utensil into said safety goggle writing utensil holder when a user is finished using said writing utensil.
